(19) United States
(12) Patent Application Publication
(10) Pub. No.: US 2015/0357757 A1
(43) Pub. Date: Dec. 10, 2015

(54) ELECTRICAL CONNECTOR ASSEMBLY WITH IMPROVED SHELL

(71) Applicant: FOXCONN INTERCONNECT TECHNOLOGY LIMITED, Grand Cayman (KY)

(72) Inventors: XIN-HUA WU, Kunshan (CN); YUNG-CHANG CHENG, New Taipei (TW)

(21) Appl. No.: 14/731,430

(22) Filed: Jun. 5, 2015

(30) Foreign Application Priority Data
Jun. 5, 2014 (CN) 201410246357.8

(51) Int. Cl. H01R 13/639; H01R 31/06

(52) U.S. Cl. CPC H01R 13/639; H01R 31/06

(57) ABSTRACT

An electrical connector assembly includes an adapter connector (10), a plug connector (20), and a pivoting member assembly (30) assembled between the adapter connector and the plug connector. The adapter connector includes a first connector (110), a second connector (120), and a first shell (140) enclosing on the first connector and the second connector. The plug connector includes a third connector (220) and a second shell (210) enclosing the third connector. The pivoting member assembly includes a first pivoting member (310) assembled on the first shell, a second pivoting member (320) assembled on the second shell and a third pivoting member (330) pivotally connected between the first pivoting member and the second pivoting member, wherein the first pivoting member and the second pivoting member are rotatable relative to the third pivoting member to connect/disconnect the adapter connector to/from the plug connector.

### BACKGROUND OF THE INVENTION

1. Field of the Invention

The present invention relates to an electrical connector assembly including an adapter connector and a plug connector, and more particularly to an electrical connector assembly having plural pivoting members connected between adapter and plug housings.

2. Description of Related Art

To connect a plug connector to an electronic device generally requires the plug connector to have conforming interface, such as specification and profile, with a socket connector of the electronic device; if the interface does not match, usually an additional adapter connector is needed. The adapter is usually separated from the plug connector when not in use, thus making it easy to get lost.

U.S. Pat. No. 7,473,141 discloses a transfer plug for a variety of sockets, including an adapter connector and a plug connector. The adapter connector includes an insulating shell having a first and a second connectors, and two arms each having one end pivotally connected to the shell. Another end of the arm is pivotally and slidable connected to the plug connector. The signal plug is pivotable relative to the insulating shell in generally up and down directions, in contrast to a horizontal direction, within a limited range.

An electrical connector assembly with improved pivoting members is desired.

### BRIEF SUMMARY OF THE INVENTION

Accordingly, an object of the present invention is to provide an electrical connector assembly having improved shell and pivoting members.

In order to achieve the above-mentioned object, an electrical connector assembly in accordance with the present invention comprises: An electrical connector assembly comprising: an adapter connector having a first connector, a second connector electrically connected to the first connector, and a first shell enclosing the second connector and a rear end of the first connector, a plug connector having a third connector for mating with the second connector and a second shell enclosing a rear end of the third connector; and a pivoting member assembly including a first pivoting member pivotally assembled to the first shell, a second pivoting member pivotally assembled to the second shell, and a third pivoting member pivotally connected at one end thereof to the first pivoting member and at another end thereof to the second pivoting member.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of an electrical connector assembly according to the present invention, in which an adapter connector is assembled with a plug connector;

FIG. 2 is an exploded view of the electrical connector assembly shown in FIG. 1; and

FIGS. 3-5 are perspective views of the electrical connector assembly similar to FIG. 1, but in which the plug connector is not mated to the adapter connector.

### DETAILED DESCRIPTION OF THE PREFERRED EMBODIMENT

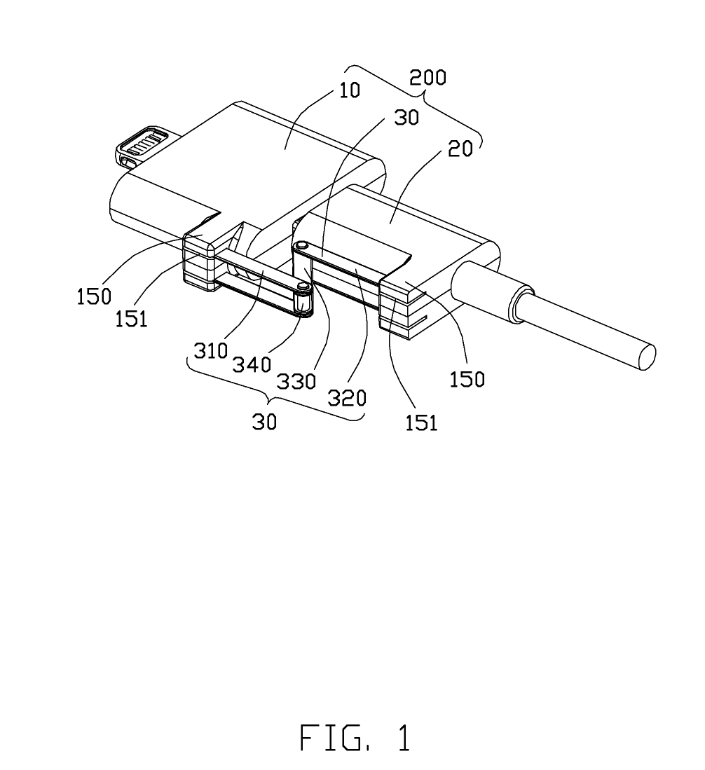

Referring to FIG. 1, a electrical connector assembly 200 in accordance with the present invention comprises a plug connector 20, a adapter connector 10 used in conjunction with the plug connector 20, and a pivoting member assembly 30 assembled between the plug connector 20 and the adapter connector 10.

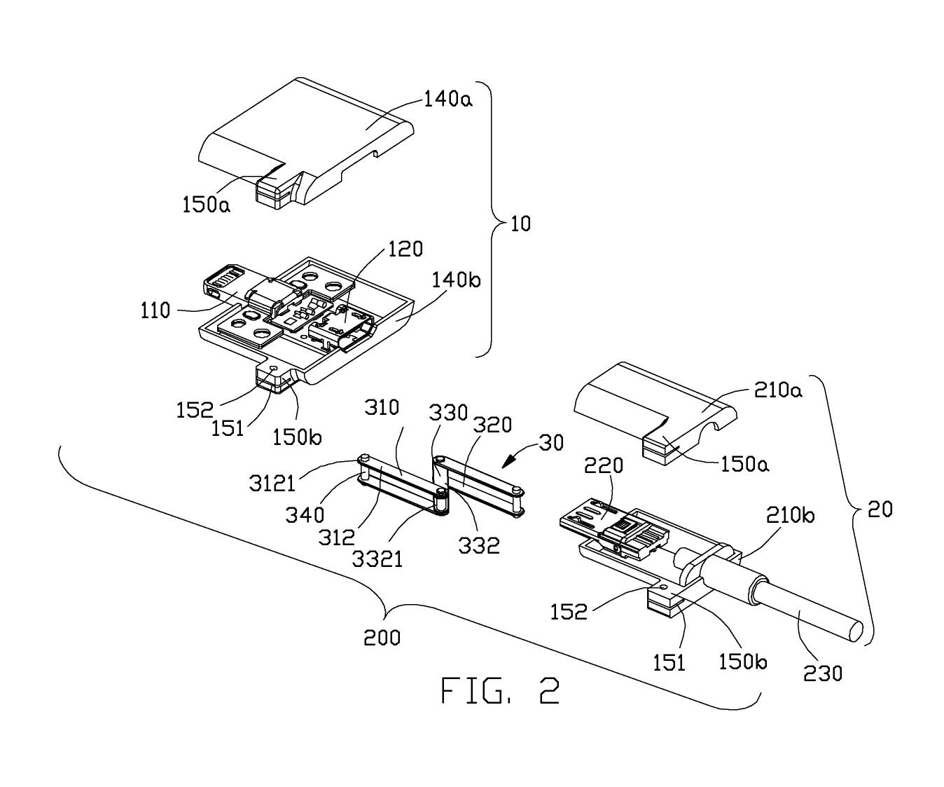

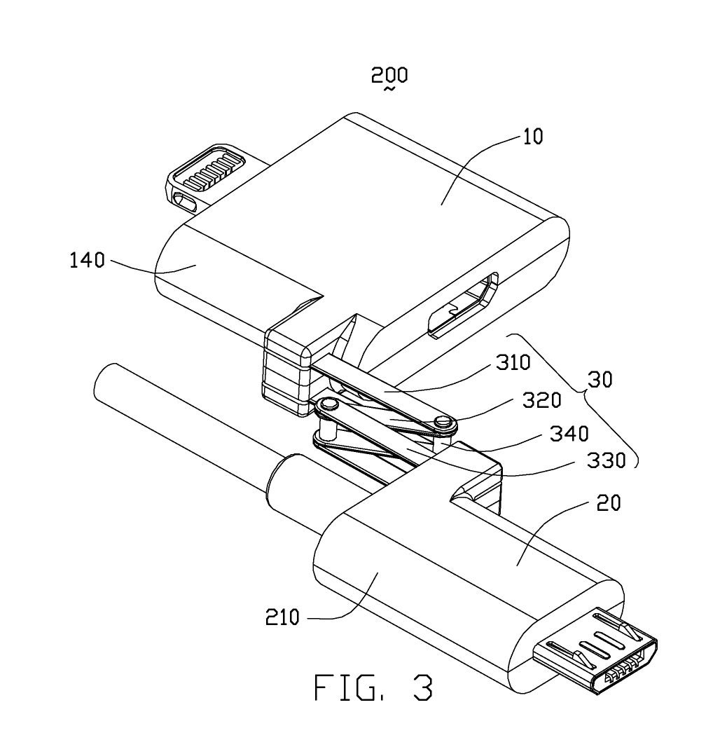

Referring to FIGS. 2 and 3, the adapter connector 10 comprises a first connector 110 defined on a first end of the adapter connector 10, a second connector 120 eclectically connected to the first connector 110 and defined on a second end of the adapter connector 10, and a first shell 140. The first connector 110 accordance with the present invention may be a plug type or male type connector, the second connector 120 may be a receptacle or female type connector.

Referring to FIG. 2, the first shell 140 includes a first portion 140a and a second portion 140b, the first portion 140a and second portion 140b are engaged with each other oppositely forming a receiving space for receiving the first connector 110 and the second connector 120 therein. An end of the first connector 110 is exposed from a front end of the first shell 140.

Referring to FIGS. 2 and 3, the plug connector 20 includes a second shell 210, a third connector 220 fixed in a front end of the second shell 210 and exposed from therein, and a cable 230 through a rear end of the second shell 210 and electrically connected to the third connector 220. When the adapter connector 10 is used, the third connector 220 is electrically connected to the second connector 120.

The second shell 210 includes a first portion 210a and a second portion 210b, the first portion 210a and second portion 210b are engaged with each other oppositely forming a receiving space for receiving the third connector 220 therein. A front end of the third connector 220 exposes from the second shell 210.

Two fixing portions 150 are extended form the first shell 140 and the second shell 210 respectively. A fixing portion 150 includes a first fixing portion 150a extended form the first portion 140a, and a second fixing portion 150b extended form the second portion 140b of the first shell 140. Another fixing portion 150 includes a first fixing portion 150a extended from the first portion 210a, and a second fixing portion 150b extended form the second portion 210b of the second shell 210. A gap 151 is defined on each of the first fixing portion 150a and the second fixing portion 150b along a first plane which parallel to a mating direction. Each of the first fixing portions 150a is parallel to the corresponding second fixing portion 150b at intervals. A pivoting hole 152 is defined on each of the first fixing portion 150a and the second fixing portion 150b therethrough along a second direction which perpendicular to the first plane.

The pivoting member assembly 30 includes a first pivoting member 310 assembled on the adapter connector 10, a second pivoting member 320 assembled on the plug connector 20, a third pivoting member 330 pivotally connected between the first pivoting member 310 and the second pivoting member 320, and four connecting member 340. The four connecting member 340 is a pivot shaft or other connecting member for providing pivotally connection. Each of the first pivoting member 310 and the second pivoting member 320 includes two connecting plates 312 parallel to each other. Two through-holes 3121 are defined on opposite ends of the connecting plates 312 respectively. An end of the connecting plates 312 of the first pivoting member 310 are inserted to the gaps 151 of the first shell 140, each end of a connecting member 340 is passed through a through-hole 3121 of the first pivoting member 310 by inserting into the corresponding pivoting hole 152, by this way, the connecting plates 312 of the first pivoting member 310 are pivotally connected to the fixing portion 150 of the first shell 140. An end of the connection plates 312 of the second pivoting member 320 are inserted to the gaps 151 of the second shell 210, each end of a connecting member 340 is passes through a through-hole 3121 of the second pivoting member 320 by inserting into the corresponding pivoting hole 152, by this way, the two connection plates 312 of the second pivoting member 320 are pivotally connected to the fixing portion 150 of the second shell 210. The third pivoting member 330 includes two pivoting plates 332 parallel to each other. Two though-holes 3321 are defined on opposite ends of the pivoting plate 332 respectively. Each end of a connecting member 340 is passed through a through-hole 3321 of the pivoting plates 322 and a corresponding through-hole 3121 of the connecting plates 312, and thus the first pivoting member 310 and the second pivoting member 320 are pivotally connected by the third pivoting member 310.

In this embodiment in accordance with the present invention, the first pivoting member 310 is pivotally assembled to the first shell 140, the second pivoting member 320 is pivotally assembled to the second shell 210, thus, the adapter connector 10 can be rotated relative to the first pivoting member 310 in the first plane parallel to the connecting plates 312, and the plug connector 20 can be rotated relative to the second pivoting member 320 in the first plane. Both ends of the third pivoting member 330 are pivotally connected to the first pivoting member 310 and the second pivoting member 320 respectively so that the first pivoting member 310 may be rotated relative to the second pivoting member 320 in a plane parallel to the pivoting plates 322. In other embodiments, the first pivoting member 310 can be fixed to the adapter connector 10, and the second pivoting member 320 can be fixed to the plug connector 20 by other means, such as riveting, screw locks, etc, and then both ends of the third pivoting member 330 are connected to the first pivoting member 310 and the second pivoting member 320 respectively, thus the adapter connector 10 together with the first pivoting member 310 can be rotated relative to the second pivoting member 320, and the plug connector 20 together with the second pivoting member 320 can be rotated relative to the first pivoting member 310. In this embodiment in accordance with the present invention, the pivoting connection between the first pivoting member 310 and the third pivoting member 330 and the pivoting connection between the second pivoting member 320 and the third pivoting member 330 are achieved by engagements of two opposite plates and a shaft.

Referring to FIG. 1, when connecting the adapter connector 10 to the plug connector 20, the second pivoting member 320 is rotated relative to the plug connector 20 to make the third connector 220 and the second pivoting member 320 on a same side of the fixing portion 150 of the plug connector 20; the first pivoting member 310 is rotated relative to the adapter connector 10 to make the first pivoting member 310 and the second connector 120 on a same side of the fixing portion 150 of the adapter connector 10; and the third pivoting member 330 is rotated relative to the first pivoting member 310 and the second pivoting member 320 respectively to make the third connector 220 on a right position ready to be connected with the second connector 120 of the adapter connector 10.

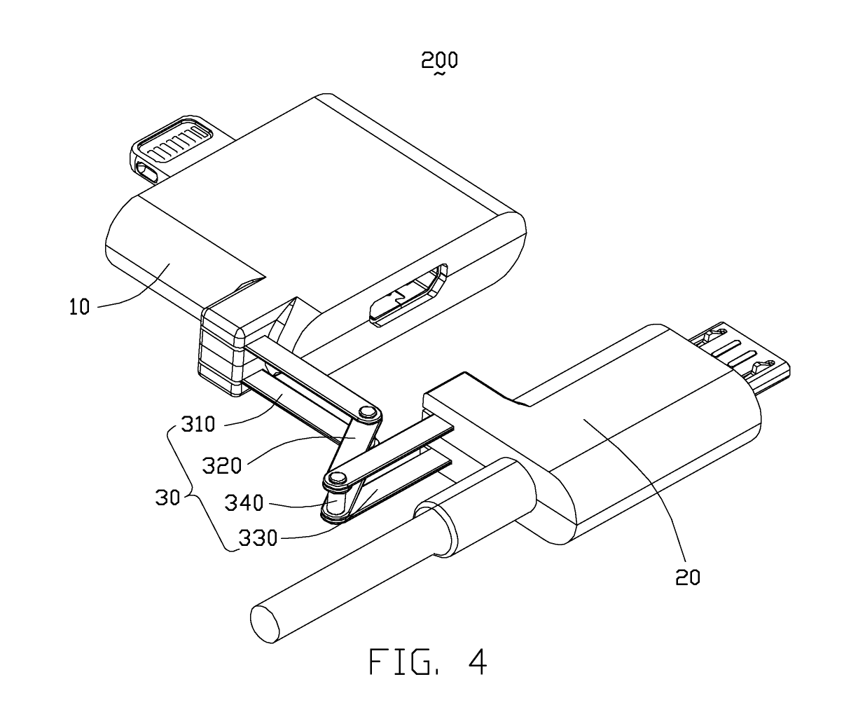

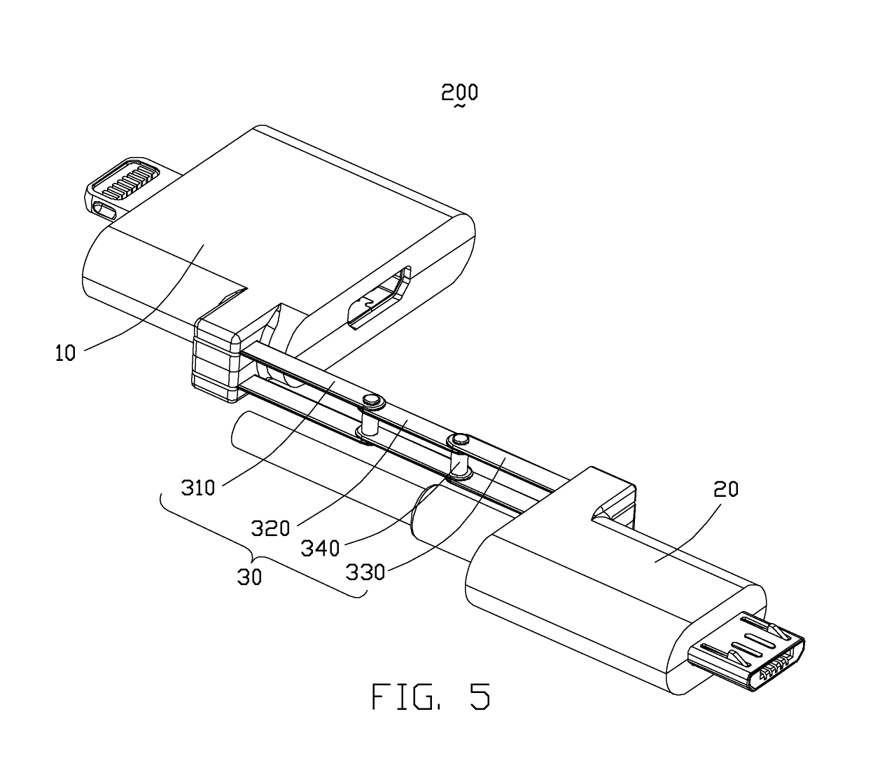

Referring to FIGS. 3 to 5, when dismantling the adapter connector 10 from the plug connector 20, the third pivoting member 330 is rotated relative to the first pivoting member 310 and the second pivoting member 320 to break the adapter connector 10 away from the plug connector 10; the second pivoting member 320 is rotated relative to the plug connector 20 to make the second pivoting member 320 and the third connector 220 on opposite sides of the fixing portion 150 of the plug connector 20. In order to make it easy to connect the plug connector 20 to a socket connector of a electrical device, the third pivoting member 330 can be rotated arbitrarily on the plane parallel to the pivoting plates 322, and as a result, the adapter connector 10 can be placed on any position beside the plug connector 20, such as side and rear, as shown in the FIGS. 4 and 5. Notably, the first pivoting member 310, the second pivoting member 320 and the third pivoting member 330 might be pivotally loosely, with somewhat clearances, linked with one another so as to forgive relative displacements among them when the plug connector 20 is mated with the adapter connector 10.

What is claimed is:

1. An electrical connector assembly comprising:
an adapter connector having a first connector, a second connector electrically connected to the first connector, and a first shell enclosing the second connector and a rear end of the first connector;
a plug connector having a third connector for mating with the second connector and a second shell enclosing a rear end of the third connector; and
a pivoting member assembly including a first pivoting member pivotally assembled to the first shell, a second pivoting member pivotally assembled to the second shell, and a third pivoting member pivotally connected at one end thereof to the first pivoting member and at another end thereof to the second pivoting member.

2. The electrical connector assembly as recited in claim 1, wherein the third pivoting member includes a pivoting plate having one end pivotally connected to the first pivoting member and another end pivotally connected to the second pivoting member, and the first pivoting member is rotatable relative to the second pivoting member in a plane parallel to the pivoting plate.

3. The electrical connector assembly as recited in claim 2, wherein the pivoting member assembly includes a number of connecting members, a through-hole is defined on each end of the pivoting plate, a through-hole is defined on an end of the first pivoting member, a through-hole is defined on an end of the second pivoting member, the connecting member is a shaft, a connecting member extends through the through-hole of the first pivoting member and a through-hole of the third pivoting member, and another connecting member extends through the through-hole of the second pivoting member and another through-hole of the third pivoting member.

4. The electrical connector assembly as recited in claim 1, wherein a fixing portion is extended from the first shell, and the first pivoting member is pivotally connected to the fixing portion.

5. The electrical connector assembly as recited in claim 4, wherein a fixing portion is extended from the second shell, and the second pivoting member is pivotally connected to the fixing portion of the plug connector.

6. The electrical connector assembly as recited in claim 5, wherein a respective pivoting hole is defined on each of the fixing portions of the adapter connector and the plug connector, a through-hole is defined on an end of the first pivoting member, a through-hole is defined on an end of the second pivoting member, a connecting member is passed through the pivoting hole of the adapter connector and the through-hole of the first pivoting member, and another connecting member is passed through the pivoting hole of the plug connector and the through-hole of the second pivoting member.

7. The electrical connector assembly as recited in claim 6, wherein both of the first pivoting member and the second pivoting member includes a connecting plate, and the through-holes by which the first pivoting member connected to the adapter connector and the third pivoting member are defined on both ends of the connecting plate of the first pivoting member, the through-holes by which the second pivoting member connected to the plug connector and the third pivoting member are defined on both ends of the connecting plate of the second pivoting member.

8. The electrical portion assembly as recited in claim 7, wherein a gap is defined on each of the fixing portions of the adapter connector and the plug connector, and one end of the connecting plate is inserted in the gap to align the through-hole and the corresponding pivoting hole.

9. The electrical portion assembly as recited in claim 1, wherein:
each of the first shell and the second shell includes a first portion and a second portion engaged with the first portion;
each of the first portions and the second portions includes a gap parallel to a mating direction and a pivoting hole;
each of the first pivoting member and the second pivoting member includes two connecting plates parallel to each other;
the third pivoting member includes two pivoting plates parallel to each other; and
the connecting plates of the first pivoting member are inserted into the gaps of the adapter connector and pivotally connected to the first portion and the second portion of the adapter connector respectively by corresponding pivoting holes, and the connecting plates of the second pivoting member are inserted into the gaps of the plug connector and pivotally connected to the first portion and the second portion of the plug connector respectively by corresponding pivoting holes.

10. An electrical connector assembly comprising:
an adapter connector having a first connector, a second connector electrically connected to the first connector;
a plug connector having a third connector adapted for mating with the second connector and a cable connected behind the third connector; and
a pivoting member assembly linked between the adapter connector and the plug connector; wherein
said pivoting member assembly includes a first bar, a second bar and a third bar pivotally assembled with one another so as to form a Z-shaped configuration when the third connector is mated with the second connector.

11. The electrical connector assembly as claimed in claim 10, wherein the adapter connector and the first bar are pivotal with each other via a first pivot axis, the first bar and the second bar are pivotal with each other via a second pivot axis, the second bar and the third bar are pivotal with each other via a third pivot axis, and the third bar and the plug connector are pivotal with each other via a fourth pivot axis.

12. The electrical connector assembly as claimed in claim 11, wherein all said first pivot axis, said second pivot axis, said third pivot axis and said fourth pivot axis extend in a vertical direction perpendicular to a mating direction between the second connector and the third connector.

13. The electrical connector assembly as claimed in claim 10, wherein material of said pivoting member assembly is rigid.

14. The electrical connector assembly as claimed in claim 10, wherein said pivoting member assembly is located by one lateral side of said adapter connector and said plug connector.
